(19) United States
(12) Patent Application Publication
(10) Pub. No.: US 2018/0243854 A1
(43) Pub. Date: Aug. 30, 2018

(54) SPOT POSITION CORRECTING METHOD AND APPARATUS

(71) Applicant: HONDA MOTOR CO., LTD., MINATO, TOKYO (JP)

(72) Inventor: Tetsuya YOSHINO, HAGAGUN, TOCHIGI-KEN (JP)

(21) Appl. No.: 15/552,978

(22) PCT Filed: Feb. 24, 2016
(86) PCT No.: PCT/JP2016/055455

§ 371 Date: Aug. 23, 2017

(30) Foreign Application Priority Data
Feb. 25, 2015 (JP) 2015-035027

(51) Int. Cl. B23K 11/25; B23K 11/11; B23K 31/02; B25J 9/16

(52) U.S. Cl. CPC B23K 11/253; B23K 11/11; B25J 9/163; B25J 9/1684; B23K 31/02

(57) ABSTRACT

According to the present invention, a plurality of actual spots where normal directions of welding surfaces are parallel to each other and arranged successively, are set as a spot group. Then, when the actual spots included in the spot group are collectively moved in the same direction by the same distance, a search is conducted of candidates for the directions and the distances that cause the actual spots having been moved to approach welding points. Further, optimum direction and distance are selected from among the candidates for the directions and distances, and a plurality of teaching points corresponding to the plurality of actual spots included in the spot group are corrected by using the selected direction and distance.

### TECHNICAL FIELD

The present invention relates to a spot position correcting method and apparatus for correcting positional deviation between an actual spot at which a welding robot actually performs a welding operation and a welding spot of a workpiece.

### BACKGROUND ART

The working robot operates according to teaching data created by, for example, offline teaching. In the case of a welding robot, a welding spot on the design of the workpiece is set as the teaching point of the teaching data. However, when the welding robot operates, the actual spot at which the welding robot actually performs the welding operation may deviate from the welding spot of the workpiece.

The deviation of the spot is caused by the operational error of each joint of the welding robot, the deviation of the installation position of the welding robot, and the like. In order to eliminate the deviation of the actual spot from the welding spot, it is desirable to perform the operation for correcting the teaching point after the offline teaching.

As one method of correcting the teaching point, there is a method of individually correcting the teaching point using a teaching pendant. With this method, the teaching point can be reliably corrected. On the other hand, this method has a drawback that it takes a lot of time if there are so many actual spots misaligned.

For example, Japanese Laid-Open Patent Publication No. 2001-105153 discloses a technique capable of correcting a teaching point in a short time. Japanese Laid-Open Patent Publication No. 2001-105153 discloses the technique to monitor the current value of a servomotor that drives each shaft of a robot while a welding gun grips a workpiece. When the current value is larger than a predetermined value, it is determined that the actual spot is deviated from the actual spot. Then, the spot position at which the current value becomes smaller is specified while moving the spot position. Furthermore, all subsequent teaching points are judged misaligned in the same way, and all the subsequent teaching points are corrected with the same correction amount. According to this technique, since a plurality of teaching points can be corrected at one time, correction efficiency can be improved.

### SUMMARY OF INVENTION

In the technique described in Japanese Laid-Open Patent Publication No. 2001-105153, a displacement direction and a displacement distance for correcting positional deviation of a specific teaching point are used to correct all subsequent teaching points. However, there are cases where the displacement direction and the displacement distance are not applicable. For example, in the case where the positional deviation of a specific teaching point is caused by a mere teaching error, if the subsequent teaching points are corrected with the displacement direction and the displacement distance for correcting the positional deviation of a specific teaching point, the correction causes deviations of the subsequent teaching points. As described above, the technique described in Japanese Laid-Open Patent Publication No. 2001-105153 has a problem in the correction accuracy of the teaching point.

The present invention has been made in consideration of such problems, and an object thereof is to provide a spot position correcting method and apparatus capable of efficiently correcting a teaching point of a welding robot and improving correction accuracy.

The method according to the present invention is a method for correcting a positional deviation between an actual spot for a welding robot operating according to a teaching point and a welding spot on a workpiece, comprising the steps of: measuring positions of a plurality of actual spots for the welding robot; setting the plurality of actual spots arranged in succession and having normal directions to welding surfaces parallel to each other, as one spot group; searching candidates for a direction and distance with which the plurality of actual spots after displacement respectively approaches the welding spots on the workpiece when the plurality of actual spots set as the one spot group are displaced all together in a same direction by a same distance; selecting a direction and distance most suitable as a correction direction and distance from among the candidates for the direction and distance; and correcting a plurality of teaching points corresponding to the plurality of actual spots in the one spot group using the direction and distance as selected.

The apparatus according to the present invention is a spot position correcting apparatus for correcting positional deviation between an actual spot for a welding robot operated according to a teaching point and a welding spot of a workpiece, the apparatus comprising: a measuring unit configured to measure positions of a plurality of actual spots for the welding robot, a setting unit configured to set the plurality of actual spots arranged in a succession and having normal directions to a welding surface parallel to each other, as one spot group; a searching unit configured to search candidates for a direction and distance with which the plurality of actual spots after displacement respectively approaches welding spots of the workpiece when the plurality of actual spots set as the one spot group by the setting unit are displaced all together in a same direction by a same distance; a selecting unit configured to select a direction and distance most suitable as a correction direction and distance from among the candidates for the direction and distance; and a correcting unit configured to correct a plurality of teaching points corresponding to the plurality of actual spots in the one spot group using the direction and distance as selected by the selecting unit.

In this way, in the present invention, the plurality of actual spots arranged in succession and having the normal directions to the weld surfaces parallel to each other are set as one spot group. Then, candidates for a direction and distance with which each actual spot after displacement approaches each welding spot when moving the plurality of actual spots included in the one spot group by the same distance in the same direction are searched. Furthermore, the most suitable direction and distance are selected from the plurality of candidates for the directions and distance, and a plurality of teaching points corresponding to the plurality of actual spots included in the one spot group are corrected using the direction and the distance as selected.

According to the present invention, a plurality of actual spots having the normal directions to the welding surface parallel to each other and arranged in succession are set as one spot group, and the teaching points corresponding to the plurality of actual spots included in the one spot group are so that they are corrected all together. Therefore, correction can be performed efficiently. Furthermore, a plurality of candidates of the displacement direction and the displacement distance for correcting the plurality of actual spots included in the one spot group are searched for, and the most suitable ones are selected as the correction direction and correction distance from among them. Therefore, it is possible to improve the accuracy of correction.

### BRIEF DESCRIPTION OF DRAWINGS

FIG. 1 is a functional block diagram of a spot position correcting apparatus according to this embodiment;

FIG. 2 is a flowchart of a spot position correcting process according to this embodiment;

FIG. 3 is a diagram for explaining a spot group;

FIG. 4 is a view showing an actual spot and a welding spot located near the actual spot and;

FIG. 5 is a view showing candidates for a direction and distance to move three actual spots; and

FIGS. 6A to 6D are diagrams showing distance differences between the welding spots and the actual spots moved by respective vectors.

### DESCRIPTION OF EMBODIMENTS

Preferred embodiments of a method and an apparatus for correcting a spot position according to the present invention will be described in detail below with reference to the accompanying drawings.

### [Configuration of Spot Position Correcting Apparatus 10]

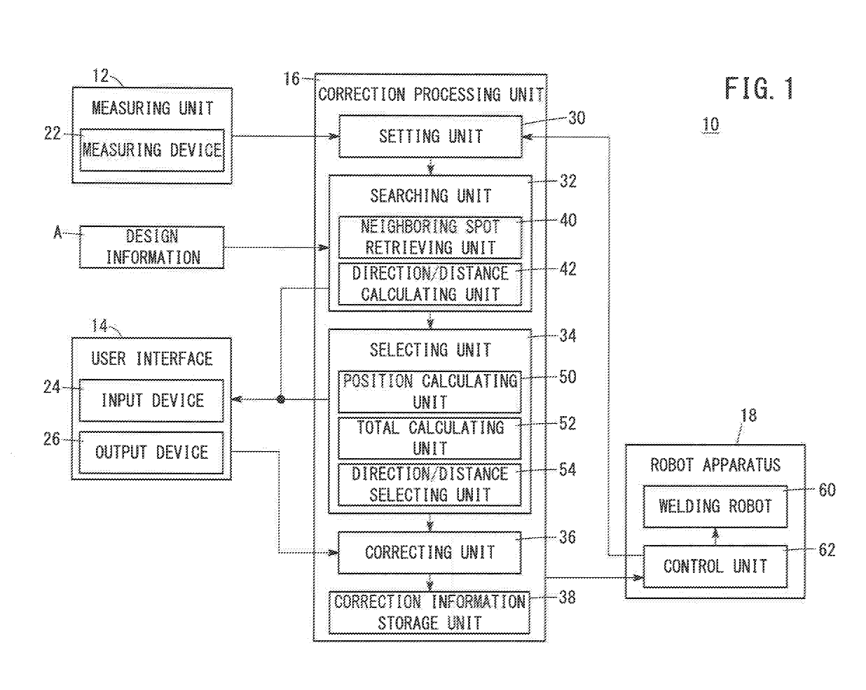

With reference to FIG. 1, the configuration of a spot position correcting apparatus 10 according to this embodiment will be described. The spot position correcting apparatus 10 includes: a measuring unit 12 for measuring the position of an actual spot for a welding robot 60; a user interface 14 through which a user such as an operator can exchange information with a correction processing unit 16; the correction processing unit 16 that executes correction processing; and a robot apparatus 18 that includes the welding robot 60.

The measuring unit 12 includes a measuring device 22 capable of measuring the position of a welding gun in the space, for example, a device for actually measuring the rotation angle of each joint and each rotating shaft of the welding robot 60 (encoder or the like), and a device for calculating the position of the welding gun based on the rotation angle of the shaft. The measuring unit 12 outputs information (coordinate information) on the position measured by the measuring device 22 to the correction processing unit 16.

The measuring unit 12 may be provided with a measuring device 22 capable of measuring the position in the space, for example, a laser tracker. In the case of using the laser tracker, a reflector is installed in the welding gun of the welding robot 60 so that the actual spot can be calculated from the position of the reflector.

The user interface 14 includes an input device 24 such as a mouse and a keyboard, and an output device 26 such as a display, a speaker, and a printer. The user interface 14 inputs the information input via the input device 24 to the correction processing unit 16. The output device 26 outputs the information output from the correction processing unit 16.

The correction processing unit 16 includes a CPU that performs various arithmetic processing, a memory that stores various data, an input/output unit that inputs and outputs data, and the like, and is configured by, for example, a personal computer. The correction processing unit 16 functions as a setting unit 30, a searching unit 32, a selecting unit 34, and a correcting unit 36 by executing a program stored internally or externally. Further, the correction processing unit 16 includes a correction information storage unit 38 that stores the corrected position information. For example, the correction information storage unit 38 is a database. Furthermore, the searching unit 32 includes a neighboring spot retrieving unit 40 and a direction/distance calculating unit 42. In addition, the selecting unit 34 includes a position calculating unit 50, a total calculating unit 52, and a direction/distance selecting unit 54. The function of each part will be described below in the explanation of the spot position correction processing.

The robot apparatus 18 includes a welding robot 60 having a plurality of joints and rotating shafts, and a control unit 62 for controlling the welding robot 60. The control unit 62 stores the teaching data including the teaching points and controls the operation of the welding robot 60 using the teaching data. The teaching data includes position information (coordinate information) about the teaching point and information about the normal direction to the welding surface at the teaching point.

### [Spot Position Correction Processing]

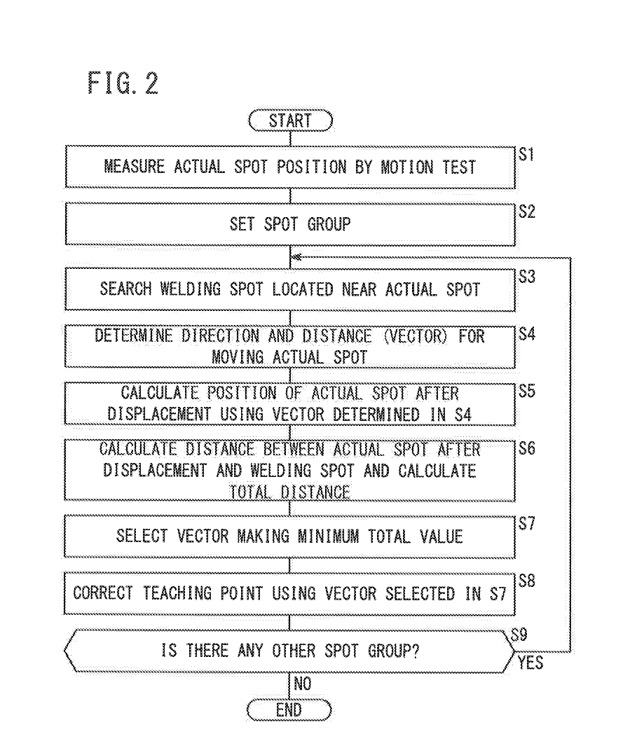

The procedure of the spot position correction processing according to this embodiment will be described with reference to FIG. 2. In the present embodiment, it is assumed that a level (not shown) serving as a reference for a specific coordinate system is installed in the installation area of the welding robot 60. The position of this level has been measured in advance by the measuring device 22 of the measuring unit 12. Then, a conversion formula for converting the position measured by the measuring device 22 into the specific coordinate system has been obtained, and thereafter, by this conversion formula, the position measured by the measuring device 22 is to be converted to the position in the specific coordinate system.

In step S1, the welding robot 60 performs a motion test and measures the position of the actual spot. When the control unit 62 operates the welding robot 60 according to the teaching data, the welding robot 60 performs the motion test at all teaching points included in the teaching data. At this time, the measuring device 22 of the measuring unit 12 measures the actual spot at which the welding robot 60 actually performs the welding operation, that is, the position of the actual spot that has been tested.

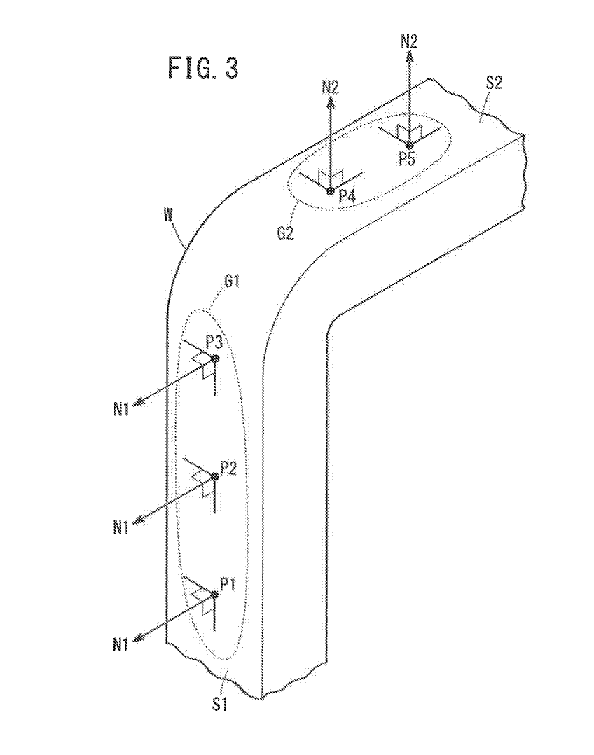

In step S2, a group of spots composed of a plurality of actual spots is set. The setting unit 30 associates the position information (coordinate information) indicating the position of the actual spot measured by the measuring device 22 with the normal direction information to the welding surface (information about the direction perpendicular to the surface) of the teaching point corresponding to the actual spot. Then, a plurality of actual spots arranged in succession and having the normal directions to the welding surface parallel to each other are set as one spot group. For example, it is assumed that the actual spots P1 to P5 are measured as shown in FIG. 3 while the welding robot 60 performs the motion test in accordance with the teaching data for welding the workpiece W. The actual spots P1 to P3 are arranged in succession and the normal directions N1 to the welding surface S1 are parallel to each other. In this case, the actual spots P1 to P3 are set as one spot group G1. In addition, the actual spots P4, P5 are arranged in succession and the normal directions N2 to the welding surface S2 are parallel to each other. In this case, the actual spots P4, P5 are set as one spot group G2. In this manner, one or more spot groups G1 and G2 are set.

In steps S3 to S4 described below, it is assumed that a plurality of actual spots Pn included in one spot group Gm are moved all together by the same distance in the same direction. Then, a process is performed to search candidates for a direction and distance such that each actual spot Pn after displacement approaches each welding spot Qn. The searching unit 32 performs this process.

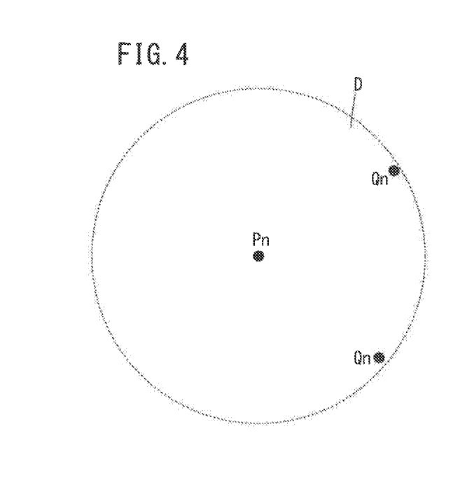

In step S3, a welding spot Qn located near the actual spot Pn is searched for each actual spot Pn. The details of the processing performed here will be specifically described with reference to FIG. 4. The neighboring spot retrieving unit 40 acquires the position information of each actual spot Pn included in the spot group Gm and the position information of each welding spot Qn included in the design information A. Then, as shown in FIG. 4, a welding spot Qn included in a predetermined range D centered on the actual spot Pn is searched and one or more found welding spots Qn are allocated as provisional correspondence spots for the actual spot Pn. The predetermined range D can be arbitrarily set or changed.

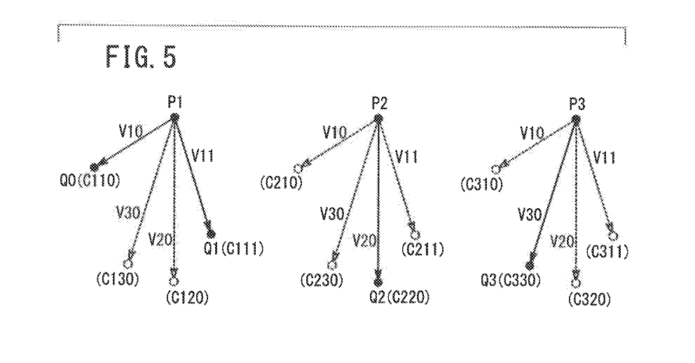

In step S4, the direction and the distance (vector Vn) for moving the actual spot Pn to the position of the welding spot Qn set as the provisional correspondence spot in step S3 are obtained. The details of the processing performed here will be specifically described with reference to FIG. 5. In the embodiment shown in FIG. 5, in step S3, two welding spots Q0, Q1 are allocated as provisional correspondence spots for the actual spot P1. The direction/distance calculating unit 42 simulates the case of moving the actual spot P1 to the position C110 of the welding spot Q0 to calculate the direction and distance of displacement, that is, the vector V10. Further, the direction/distance calculating unit 42 simulates the case of moving the actual spot P1 to the position C111 of the welding spot Q1 to calculate the direction and distance of displacement, that is, the vector V11.

In addition, a welding spot Q2 is allocated as a provisional correspondence spot for the actual spot P2. The direction/distance calculating unit 42 simulates the case of moving the actual spot P2 to the position C220 of the welding spot Q2 to calculate the direction and distance of displacement, that is, the vector V20. In addition, a welding spot Q3 is allocated as a provisional correspondence spot to the actual spot P3. The direction/distance calculating unit 42 simulates the case of moving the actual spot P3 to the position C330 of the welding spot Q3 to calculate a direction and distance, that is, the vector V30.

Four vectors V10, V11, V20, V30 are obtained by the process of step S4. These vectors V10, V11, V20, V30 are set as candidates for the direction and distance to move the spot group Gm.

In steps S5 to S7 described below, the most suitable direction and distance (vector Vn) are selected as the correction direction and the correction distance from the candidates for the plurality of directions and distances (vectors Vn) obtained in step S4. The selecting unit 34 performs this process.

In step S5, the positions after displacement are obtained with respect to all the cases where respective actual spots Pn are moved in accordance with all the directions and distances (vectors Vn) obtained in step S4.

The details of the processing performed here will be described in detail with reference to FIG. 5 used in the explanation of step S4. The position calculating unit 50 simulates the case where the spot group Gm, that is, the actual spots P1, P2, P3, is moved using the vector V10 obtained in step S4 to calculate the respective positions C110, C210, C310 after the displacement. Further, the position calculating unit 50 simulates the case where the actual spots P1, P2, P3 are moved using the vector V11 obtained in step S4 to calculate the respective positions C111, C211, C311 after the displacement. Further, the position calculating unit 50 simulates the case where the actual spots P1, P2, P3 are moved using the vector V20 obtained in step S4 to calculate the respective positions C120, C220, C320 after the displacement. Further, the position calculating unit 50 simulates the case where the actual spots P1, P2, P3 are moved using the vector V30 obtained in step S4 to calculate the respective positions C130, C230, C330 after the displacement.

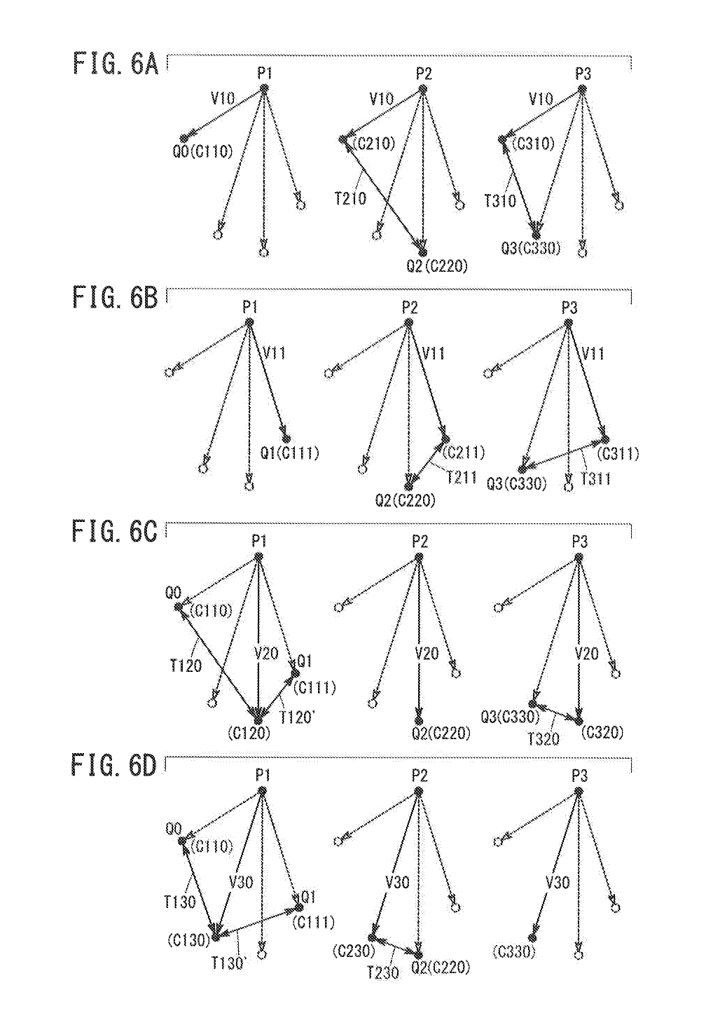

In step S6, the distance between the actual spot Pn after displacement based on the candidates for the direction and distance (vector Vn), and the welding spot Qn located in the vicinity of the actual spot Pn after displacement is computed per actual spot Pn. Further, the computed distances for respective actual spots Pn are added to determine the sum per candidate for the direction and distance (vector Vn). The details of the processing performed here will be specifically described with reference to FIGS. 6A to 6D. As shown in FIG. 6A, the total calculating unit 52 calculates the respective distances between the positions C110, C210, C310 of the actual spots after displacement from the actual spots P1, P2, P3, using the vector V10 and the positions C110, C220, C330 of the welding spots Q0, Q2, Q3 allocated as provisional correspondence spots for the actual spots P1, P2, P3. The position C110 of the actual spot P1 after the displacement coincides with the position C110 of the welding spot Q0. The position C210 of the actual spot P2 after the displacement is located apart from the position C220 of the welding spot Q2 by the distance T210. The position C310 of the actual spot P3 after the displacement is located apart from the position C330 of the welding spot Q3 by the distance T310. The total calculating unit 52 determines the total distance S (T10)=T210+T310.

Further, as shown in FIG. 6B, the total calculating unit 52 calculates the respective distances between the positions C111, C211, C311 of the actual spots after displacement from the actual spots P1, P2, P3 using the vector V11 and the positions C111, C220, C330 of the welding spots Q1, Q2, Q3 allocated as provisional correspondence spots for the actual spots P1, P2, P3. The position C111 of the actual spot P1 after the displacement coincides with the position C111 of the welding spot Q1. The position C211 of the actual spot P2 after the displacement is located apart from the position C220 of the welding spot Q2 by the distance T211. The position C311 of the actual spot P3 after the displacement is located apart from the position C330 of the welding spot Q3 by the distance T311. The total calculating unit 52 determines the total distance S (T11)=T211+T311.

Further, as shown in FIG. 6C, the total calculating unit 52 calculates the respective distances between the positions C120, C220, C320 of the actual spots after displacement from the actual spots P1, P2, P3 using the vector V20 and the positions C110, C111, C220, C330 of the welding spots Q0, Q1, Q2, Q3 allocated as provisional correspondence spots for the actual spots P1, P2, P3. The position C120 of the actual spot P1 after the displacement located apart from the position C110 of one Q0 of the welding spots by the distance T120 and from the position C111 of another Q1 of the welding spots by the distance T120′. The position C220 of the actual spot P2 after the displacement coincides with the position C220 of the welding spot Q2. The position C320 of the actual spot P3 after the displacement is located apart from the position C330 of the welding spot Q3 by the distance T320. The total calculating unit 52 determines the two total distances S (T20)=T120+T320, and S′ (T20)=T120′+T320.

Further, as shown in FIG. 6D, the total calculating unit 52 calculates the respective distances between the positions C130, C230, C330 of the actual spots after displacement from the actual spots P1, P2, P3 using the vector V30 and the positions C110, C111, C220, C330 of the welding spots Q0, Q1, Q2, Q3 allocated as provisional correspondence spots for the actual spots P1, P2, P3. The position C130 of the actual spot P1 after the displacement located apart from the position C110 of one Q0 of the welding spots by the distance T130 and from the position C111 of another Q1 of the welding spots by the distance T130′. The position C230 of the actual spot P2 after the displacement is located apart from the position the position C220 of the welding spot Q2 by the distance T230. The position C330 of the actual spot P3 after the displacement coincides with the position C330 of the welding spot Q3. The total calculating unit 52 determines the two total distances S (T30)=T130+T230, and S′ (T30)=T130′+T230.

In step S7, the direction and distance (vector Vn) in which the total calculated in step S6 is the minimum value are selected. The direction/distance selecting unit 54 selects the minimum value from among the six sums S (T10), S (T11), S (T20), S′ (T20), S (T30) and S′ (T30) calculated in step S6. Then, the vector Vn that provides the selected sum is selected as the most suitable direction and distance as the correction direction and correction distance. For example, when the sum S (T11) is the minimum value, the vector V11 is selected.

In step S8, a plurality of teaching points corresponding to the plurality of actual spots Pn included in the spot group Gm are corrected using the direction and the distance (vector Vn) selected in step S7. The correcting unit 36 uses the direction and the distance (vector Vn) selected in step S7 to collectively correct the position information of the teaching point corresponding to the spot group Gm among the teaching points stored in the control unit 62 of the robot apparatus 18. The correction information storage unit 38 stores the position information of the corrected teaching point.

If there is another spot group Gm (step S9: YES) in step S9, the process returns to step S3 and the processes of steps S3 to S8 are repeated. On the other hand, if there is no other spot group Gm (step S9: NO), the spot position correction process is terminated.

It is also possible to display the calculation result of the total calculated in step S6 on the display of the output device 26. In this case, it is also possible for the user to select the direction and distance (vector Vn) in which the total is the minimum value via the input device 24. It is also possible to display on the display of the output device 26 the position information of the corrected teaching points stored in the correction information storage unit 38 in step S9.

In step S6, it is also possible to set a threshold value for the distance between the actual spot Pn after the displacement and the welding spot Qn located in the vicinity thereof. It is also possible to select only the actual spot Pn where the distance between the actual spot Pn after the displacement and the welding spot Qn located in the vicinity thereof falls within the threshold value and perform the steps subsequent to step S7. In this case, with respect to the actual spot Pn, the distance from which after the displacement to the nearest welding spot Qn exceeds the threshold value, the positional displacement may be corrected individually.

### SUMMARY OF THE EMBODIMENT

The method according to the present embodiment relates to a spot position correcting method for correcting the positional deviation between the actual spot Pn of the welding robot 60 operating according to the teaching points and the welding spot Qn on the workpiece W. The method includes a measuring step (step S1) of measuring positions of a plurality of actual spots Pn of the welding robot 60, a setting step (step S2) of setting the plurality of actual spots Pn arranged in succession and having normal directions to welding surfaces parallel to each other, as one spot group Gm; a searching step (steps S3 to S4) of searching candidates for a direction and distance (vector Vn) with which the plurality of actual spots Pn after displacement respectively approaches the welding spots Qn when the plurality of actual spots Pn included in the one spot group Gm set in the setting step (step S2) are displaced all together in a same direction by a same distance (vector Vn); a selecting step (steps S5 to S7) of selecting the most suitable direction and distance (vector Vn) as a correction direction and a correction distance from among the candidates (vectors Vn) for the direction and distance, and a correcting step (step S8) of correcting the plurality of teaching points corresponding to the actual spots Pn included in the one spot group Gm, using the direction and distance (vector Vn) selected in the selecting step (step S7).

In the present embodiment, the processing of steps S1 to S8 are executed in the following apparatus configuration. That is, the measuring unit 12 measures the positions of the plurality of actual spots Pn of the welding robot 60. The setting unit 30 sets the plurality of actual spots Pn arranged in succession and having normal directions to the welding surface parallel to each other, as one spot group Gm. In the case where the searching unit 32 moves the plurality of actual spots Pn included in the one spot group Gm set by the setting unit 30 collectively by the same distance in the same direction (vector Vn), the searching unit 32 searches candidates for a direction and distance (vector Vn) such that the respective actual spots Pn approach the respective welding spots Qn. The selecting unit 34 selects the most suitable direction and distance (vector Vn) as the correction direction and the correction distance from among the candidates (vectors Vn) for a direction and distance. The correcting unit 36 corrects a plurality of teaching points corresponding to the plurality of actual spots Pn included in the spot group Gm by using the direction and the distance (vector Vn) selected by the selecting unit 34.

According to the present embodiment, a plurality of actual spots Pn having the normal directions to the welding surface parallel to each other and arranged in succession is set as one spot group Gm, and the teaching points corresponding to the plurality of actual spots Pn included in the spot group Gm are corrected all together. Therefore, correction can be performed efficiently. Further, a plurality of candidates for the displacement direction and the displacement distance (vector Vn) for correcting the plurality of actual spots Pn included in the spot group Gm are searched, and the most suitable correction direction and correction distance are selected therefrom. Therefore, it is possible to improve the accuracy of correction.

In the method according to the present embodiment, the search step (steps S3 to S4) includes a neighboring spot search step (step S3) for searching a welding spot Qn located near the actual spot Pn for each actual spot Pn, and a direction/distance calculation step (step S4) for calculating the direction and distance (vector Vn) for moving the actual spot Pn to the welding spot Qn retrieved in the neighboring spot search step (step S3). All the directions and distances (vectors Vn) calculated in the direction/distance calculation step (step S4) are taken as the candidates for a direction and distance (vector Vn).

In the present embodiment, the processing of steps S3 to S4 is executed in the following apparatus configuration. That is, the neighboring spot retrieving unit 40 searches for the welding spot Qn located near the actual spot Pn for each actual spot Pn. The direction/distance calculating unit 42 calculates the direction and the distance (vector Vn) for moving the actual spot Pn to the welding spot Qn retrieved by the neighboring spot retrieving unit 40.

According to the present embodiment, the direction and the distance (vector Vn) for moving the actual spot Pn to the corresponding welding spot Qn are set as a candidate for the direction and the distance (vector Vn) for moving the spot group Gm. In this way, since the existing welding spot Qn is assumed as a destination candidate, it is possible to search candidates for a direction and distance (vector Vn) efficiently.

In addition, in the method according to the present invention, the selection step (step S5 to step S7) may include a total calculating step (step S6) for calculating, with respect to each actual spot Pn, the distances between the respective actual spots Pn after displacement based on the candidate of the direction and distance (vector Vn) and the welding spot Qn located in the vicinity of the actual spots Pn after the displacement, and calculating the sum of the distances calculated for the respective actual spots Pn per candidate for the direction and distance (vector Vn), and a direction/distance selection step (step S7) for selecting the direction and distance (vector Vn) with which the sum becomes the minimum value.

In the present embodiment, the processing of steps S6 to S7 is executed in the following apparatus configuration. That is, the total calculating unit 52 calculates the distances between the actual spots Pn after displacement based on the candidates for the direction and the distance (vector Vn) and the welding spot Qn located near the actual spot Pn, with respect to each actual spot Pn. Further, the distances calculated with respect to each actual spot Pn are added per candidate of the direction and distance (vector Vn). The direction/distance selecting unit 54 selects the direction and the distance (vector Vn) with which the sum becomes the minimum value.

According to the present embodiment, since the direction and distance (vector Vn) with which the total, that is, the positional deviation amount, becomes minimal is selected, the correction accuracy of the teaching point can be improved.

1. A spot position correcting method for correcting positional deviation between actual spots for a welding robot operating according to a teaching point and welding spots on a workpiece, comprising:
a measuring step for measuring positions of a plurality of actual spots for the welding robot;
a setting step for setting the plurality of actual spots arranged in succession and having normal directions to welding surfaces parallel to each other, as one spot group;
a searching step for searching candidates for a direction and distance with which the plurality of actual spots after displacement respectively approaches the welding spots when the plurality of actual spots set as the one spot group are displaced all together in a same direction by a same distance;
a selecting step for selecting a direction and distance most suitable as a correction direction and distance from among the candidates for the direction and distance; and
a correcting step for correcting a plurality of teaching points corresponding to the plurality of actual spots in the one spot group using the direction and distance selected in the selecting step.

2. The spot position correcting method according to claim 1, wherein the searching step comprises:
a neighboring spot retrieving step for retrieving the welding spot located in a vicinity of the actual spot with respect to each actual spot; and
a direction/distance calculating step for calculating the direction and distance for moving the actual spot to the welding spot retrieved in the neighboring spot retrieving step,
wherein all the direction and distance calculated in the direction/distance calculating step are regarded as candidates for the direction and distance.

3. The spot position correcting method according to claim 1, wherein the selecting step comprises:
a total calculating step for calculating, with respect to each actual spot, distances between the actual spots after displacement based on the candidates for the direction and distance and the welding spot located in the vicinity of the actual spots after the displacement, and calculating a sum of the distances calculated with respect to each actual spot added per the candidate for the direction and distance; and
a direction/distance selecting step for selecting the direction and distance with which the sum becomes a minimum value.

4. A spot position correcting apparatus for correcting positional deviation between actual spots for a welding robot operating according to a teaching point and welding spots on a workpiece, comprising:
a measuring unit configured to measure positions of a plurality of actual spots for the welding robot;
a setting unit configured to set the plurality of actual spots arranged in succession and having normal directions to welding surfaces parallel to each other, as one spot group;
a searching unit configured to search candidates for a direction and distance with which the plurality of actual spots after displacement respectively approaches the welding spots when the plurality of actual spots set as the one spot group are displaced all together in a same direction by a same distance;
a selecting unit configured to select a direction and distance most suitable as a correction direction and distance from among the candidates for the direction and distance; and
a correcting unit configured to correct a plurality of teaching points corresponding to the plurality of actual spots in the one spot group using the direction and distance selected in the selecting unit.

5. The spot position correcting apparatus according to claim 4, wherein the searching unit comprises:
a neighboring spot retrieving unit configured to retrieve the welding spot located in a vicinity of the actual spot with respect to each actual spot; and
a direction/distance calculating unit configured to calculate the direction and distance for moving the actual spot to the welding spot retrieved in the neighboring spot retrieving unit,
wherein all the direction and distance calculated in the direction/distance calculating unit are regarded as candidates for the direction and distance.

6. The spot position correcting apparatus according to claim 4, wherein the selecting unit comprises:
a total calculating unit configured to calculate, with respect to each actual spot, distances between the actual spots after displacement based on the candidates for the direction and distance and the welding spot located in the vicinity of the actual spots after the displacement, and calculating a sum of the distances calculated with respect to each actual spot added per the candidate for the direction and distance; and
a direction/distance selecting unit configured to select the direction and distance with which the sum becomes a minimum value.
